(19) United States
(12) Patent Application Publication
(10) Pub. No.: US 2010/0019922 A1
(43) Pub. Date: Jan. 28, 2010

(54) ELECTRONIC SYSTEM CONTROL USING SURFACE INTERACTION

(75) Inventors: Evert Jan Van Loenen, Eindhoven (NL); Ronaldus Maria Aarts, Eindhoven (NL); Elmo Marcus Attila Diederiks, Eindhoven (NL); Natasha Kravtsova, Eindhoven (NL); Anthonie Hendrik Bergman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/445,465

(22) PCT Filed: Oct. 15, 2007
(86) PCT No.: PCT/IB2007/054185

§ 371 Date: Apr. 14, 2009

(30) Foreign Application Priority Data
Oct. 18, 2006 (EP) 06122523.1

(51) Int. Cl. G05B 19/02

(52) U.S. Cl. 340/825.22; 341/20

(57) ABSTRACT

Simple gestures such as stroking or tapping of a surface (10) can be used to control common functions of electronic systems (16) by positioning one or more sensors (12) on the surface and detecting sounds generated by the interaction with the surface. Signals corresponding to detected sounds are filtered and interpreted either in the system to be controlled or else in the sensors themselves. The direction of movement of a hand (18) stroking the surface can be interpreted as a command to increase or decrease a parameter, such as the sound volume level of a television, for example. Determination of the position of the user's hand is unnecessary. The apparatus is therefore simple, inexpensive, robust and discrete, requiring only a minimum of installation and without being necessarily dedicated to a particular electronic system to be controlled.

### TECHNICAL FIELD

The present invention relates to the control of electronic systems and is particularly concerned with using physical interaction with a surface to control an electronic system.

### TECHNICAL BACKGROUND

At present, most interactions with electronic systems require a user to handle a control device of some sort, such as a keyboard, a mouse or a remote control for example.

The use of such control devices has disadvantages in that the control device is often not conveniently located for the user, or else the device is a nuisance, for example causing clutter or untidiness in a domestic or office environment.

Additionally, such devices are often useful only with one particular electronic system or type of system.

“Building Intelligent Environments with Smart-Its”, p56-64, IEEE Computer Graphics and Applications, January/February 2004, describes load-sensing furniture in which load cells are installed in each corner of e.g. a table. By measuring the load on each corner of the table the center of gravity of the tabletop can be determined. By observing how the center of gravity moves, physical interaction with the surface of the table can be detected. This can be used to track electronically the movement of a finger across the surface of the table, and such movement can then be used to control a device such as a mouse pointer for a computer monitor.

However, such a technique requires each item of furniture to be specially adapted, with load sensors installed below appropriate surfaces.

### SUMMARY OF THE INVENTION

It is an object of the invention to provide apparatus for controlling an electronic system, which apparatus may unobtrusively and conveniently be located for ease of use, requiring a minimum of installation, and which may be suitable for controlling a range of electronic systems.

This object is achieved according to the invention in a control apparatus for controlling an electronic system, the apparatus comprising;

a sensor for mounting on, or in close proximity to, a surface,

wherein the sensor includes a microphone for detecting sounds caused by physical interaction with the surface; and

translation means for translating sounds detected by the microphone into one or more commands recognizable by the system,

such that physical interaction with the surface is arranged to control the operation of the system.

The sensor is mounted on or in close proximity to the surface. In a preferred embodiment the sensor is unobtrusively placed on the surface, without requiring any adaptation of furniture comprising said surface. The sensor detects sounds caused by physical interaction with the surface through the microphone. Subsequently, the detected sounds are translated by the translation means into one or more commands. These commands are recognizable by the system, and are used to control the operation of the system. This way the operation of the system is controlled through physical interaction with the surface. The advantage of such control apparatus is that there are no explicit control devices, such as e.g. a keyboard, a mouse or a remote control, needed in order to control the system.

In an embodiment, the translation means comprises one or more software modules within the system to be controlled. For example ach of the software modules can be programmed to recognize a specific type of physical interaction, e.g. a double-tap, and translate this physical interaction into a specific control function.

In a preferred embodiment, the translation means is located within the sensor. The advantage of this is that the control apparatus can be used as stand-alone, and that the system does not need to be adapted in order to be controlled by the control apparatus.

In a preferred embodiment, the sensor comprises an electronic processor. The primary function of the electronic processor is to handle an analysis, e.g. filtering and sound-intensity measurement, of the detected sounds before transmitting recognized commands to the system. Furthermore, the processor can also fulfill functions of other items cited in the embodiments.

In a preferred embodiment, the control apparatus comprises a plurality of sensors. The advantage of such arrangement is that the plurality of sensors permits detection of movement in different directions. Thus, this increases the number of commands, which can be given by the user's physical interaction with the surface.

In a preferred embodiment, the or each sensor comprises an indicator for providing an acknowledgement that the system is being controlled. It is convenient and assuring to know that the control command through the physical interaction with the surface has been properly received by the controlled system.

In an embodiment, the indicator comprises a loud speaker. This is done for the purpose to advantageously realize the indicator. The indicator could for example provide a vibration or an acoustic indication by using a small loudspeaker.

In an embodiment, the loudspeaker comprises the microphone. It would be advantageous to use the loudspeaker as a microphone, as it reduces a number of items needed to realize the control apparatus.

In one preferred arrangement the system to be controlled comprises a computer.

The invention also includes a method of controlling an electronic system, the method comprising physically interacting with a surface to generate sounds, which are electronically detected and translated into commands recognizable by the system.

Embodiments of the invention may provide that simple gestures such as stroking or tapping of a surface can be used to control common functions of electronic systems, by positioning one or more sensors on the surface and detecting sounds generated by the interaction with the surface. Signals corresponding to detected sounds are filtered and interpreted either in the system to be controlled or else in the sensors themselves. The direction of movement of a hand stroking a surface can be interpreted as a command to increase or decrease a parameter, such as the sound volume level of a television, for example. Determination of the position of the user's hand is unnecessary. The apparatus is therefore simple, inexpensive, robust and discrete, requiring only a minimum of installation and without being necessarily dedicated to a particular electronic system to be controlled.

### BRIEF DESCRIPTION OF THE DRAWINGS

Preferred embodiments of the present invention will now be described by way of example only with reference to the accompanying diagrammatic drawings in which:

FIG. 1 is a schematic view of control apparatus according to a first embodiment of the present invention;

FIG. 2 is a schematic view of control apparatus according to a second embodiment of the present invention;

FIG. 3 is a schematic view of control apparatus according to a third embodiment of the present invention; and

FIG. 4 is an alternative schematic view of the control apparatus of FIG. 3.

### DETAILED DESCRIPTION OF THE PREFERRED EMBODIMENTS

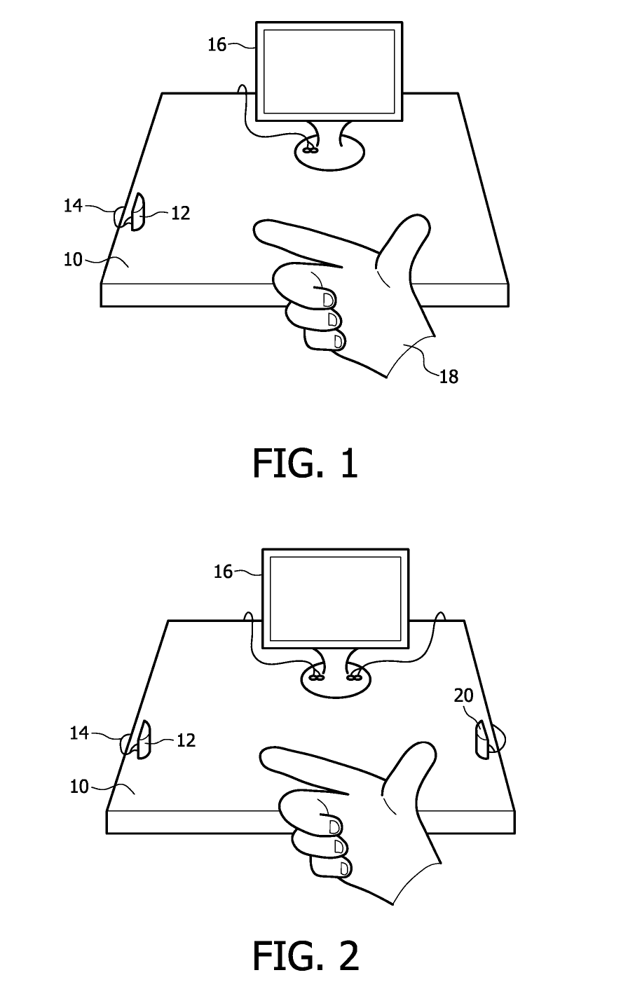

Turning to FIG. 1, this shows schematically a table surface 10 on which is located a sensor 12 connected by wires 14 to an electronic device to be controlled which is in this case a computer 16. The sensor 12 comprises a contact microphone (not shown), which is sensitive to sounds made by a user's hand, represented at 18, on the table as the user strokes or taps the table. An analogue electrical signal, generated by the microphone as a result of the sound, is transmitted along the wires 14 to the computer 16 where it is converted into a digital signal and interpreted by a translation module (not shown) using appropriate software. The translation module translates the different sounds detected by the sensor 12 as user commands for the monitor 16, such as “volume up/down”, “next/previous page” for example.

Advantageously, the absolute position of the user's hand, the detection of which would require more complicated apparatus, is irrelevant to the process of controlling the electronic device. What the microphone must detect is the direction of motion of the user's hand as it is stroked along the surface.

As a user's finger moves to stroke the table surface in a direction towards the sensor 12 the contact microphone within the sensor 12 will detect the increasing level of sound. Conversely, if the user's finger strokes the table surface in a direction away from the sensor 12 the contact microphone will detect a decreasing level of sound.

In this way simple interactions with the surface may be interpreted as commands for controlling the device 16.

FIG. 2 shows schematically a second embodiment of control apparatus in which a second sensor 20 has been added. The second sensor 20 comprises a second contact microphone (not shown) and is also connected to the computer 16 by wires.

Adding a second sensor increases the robustness of the apparatus since it permits a differential measurement to be made. In particular, to some extent background or environmental sounds will be received in common by both microphones and these can thus be filtered out by an appropriate subtraction technique during processing of the signals from the sensors. The complementary sounds detected by the microphones as a result of the user's interaction with the table surface 10 can thus be determined more accurately.

On example of a simple method of processing the microphone signals is to subtract one from the other and divide by jωp, so we get

v(t)=(p1(t)−p2(t))/jωp)

where v(t) is an estimate for the velocity, which is a vector, p1 and p2 are the microphone signals, jω is the differentiate to time operator and ρ is the density of the medium. This is based on Newton's law −ρdv(t)=dp(t)/dr where r is the vector point in space.

So the sign of v(t) bears the direction of movement with respect to the microphones, and the magnitude is its speed.

Adding further sensors permits movement in different directions to be detected, thus increasing the number of commands, which can be given by the user's physical interaction with the table surface.

If a plurality of microphones is used, assembled as a microphone array, the array can be steered or beamed by changing the weightings of the microphones. This permits a greater sensitivity in chosen directions and a reduced sensitivity in non-desired directions of sound so that the apparatus becomes less sensitive to noise. Furthermore, with such an arrangement the direction of stroking on the surface may be determined with greater ease and accuracy.

To enhance robustness further, and to inhibit the accidental interpretation of environmental sounds such as touch gestures not intended as control commands, tapping codes can be used to open an attention span, or command window, for the electronic device 16 to be controlled. For example, the translation module may be programmed to recognize a double-tap of the user's fingers on the table surface as indicative that a control command gesture is about to follow. Tapping codes could also be used to alter a function of the electronic device to be controlled. For example, in the case of a television to be controlled, the translation module could be programmed to interpret a double tap as indicative of a change in control function from “volume up/down” to “channel up/down”.

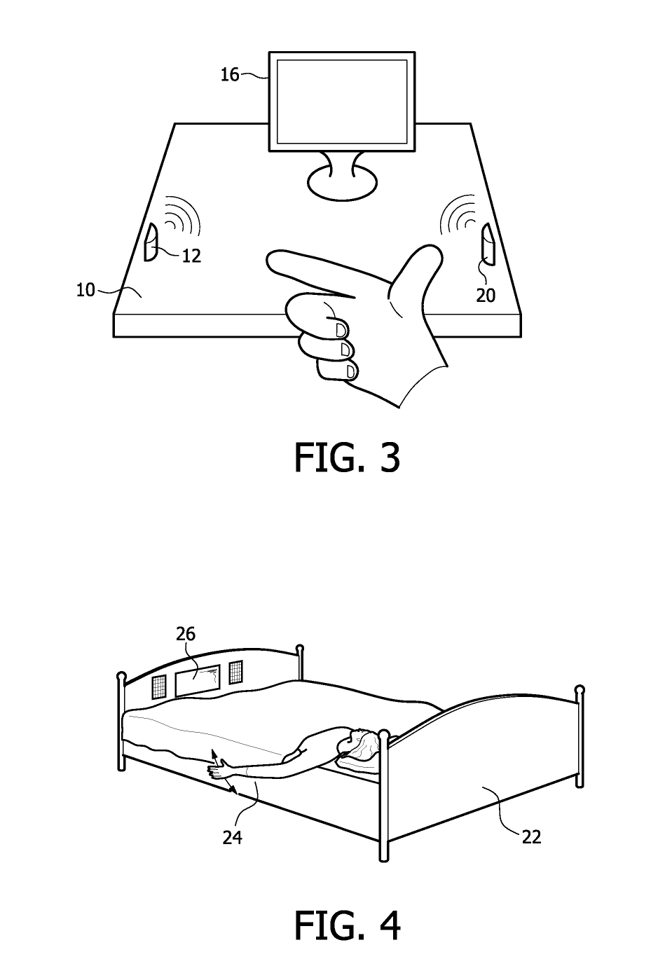

FIG. 3 shows, schematically, a further embodiment of the invention in which the sensors 12 and 20 each include embedded electronic processors (not shown), which handle the analysis (filtering and sound-intensity measurements) of the detected sounds themselves before wirelessly transmitting recognized commands to the electronic device 16.

The sensors 12, 20 may employ smart algorithms to minimize energy consumption, and/or include devices (not shown), which are able to scavenge energy from the environment, thus allowing longer battery life and simplifying installation.

FIG. 4 shows schematically a user in a bed 22 watching television. Sensor devices (not shown) of the kind described above in relation to FIGS. 1-3, are mounted on the bed frame 24. The user can control for example the channel or sound volume of a television 26 located at the foot of the bed merely by physical manual interaction with the frame of the bed without the need for the use of a dedicated remote control device.

In a further embodiment (not illustrated) the or each sensor is equipped with an indicator to provide an acknowledgment that the system is being controlled. Such an indicator could provide a visual indication, for example by utilizing an LED, or else could provide a vibration or an acoustic indication by using a small loudspeaker. Advantageously the loudspeaker could be used as the microphone.

In a still further embodiment (not shown) the stroking gestures may be combined with speech recognition to enhance functionality, since the microphones can also detect speech.

Apparatus according to embodiments of the present invention allows the convenient control of many common functions of electronic systems by simple manual interactions with existing surfaces without the need for dedicated remote control devices or the installation of complicated equipment, and without cluttering surfaces. The simple interactive solution involves the use of small, inexpensive, wireless sensors with microphones sensitive to the sounds of physical interaction, such as stroking/tapping on surfaces such as tables, bed sides, kitchen counters, desks and similar others.

The low cost of such devices lends their usefulness to homes, offices and public buildings. Users can thus control a wide variety of systems and devices using simple hand gestures without the need to seek out dedicated control devices.

An example of a small wireless sensor suitable for some applications as described above is the Philips AS1-2008.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Control apparatus for controlling an electronic system (16), the apparatus comprising;
a sensor (12) for mounting on or proximate to a surface (10), wherein the sensor includes a microphone for detecting sounds caused by physical interaction with the surface; and
translation means for translating sounds detected by the microphone into one or more commands recognizable by the system,
such that physical interaction with the surface is arranged to control the operation of the system.

2. Control apparatus according to claim 1 wherein the translation means comprises one or more software modules within the system to be controlled.

3. Control apparatus according to claim 1 wherein the translation means is located within the sensor.

4. Control apparatus according to claim 1 wherein the sensor comprises an electronic processor.

5. Control apparatus according to claim 1 comprising a plurality of sensors (12, 20).

6. Control apparatus according to claim 1 wherein the or each sensor comprises an indicator for providing an acknowledgement that the system is being controlled.

7. Control apparatus according to claim 6 wherein the indicator comprises a loud speaker.

8. Control apparatus according to claim 7 wherein the loudspeaker comprises the microphone.

9. A method of controlling an electronic system, the method comprising physically interacting with a surface to generate sounds which are electronically detected and translated into commands recognizable by the system.

10. A method according to claim 9 comprising stroking or tapping a surface.
